(19) United States
(12) Patent Application Publication
(10) Pub. No.: US 2026/0124606 A1
(43) Pub. Date: May 7, 2026

(54) CATALYST FOR FISCHER-TROPSCH REACTION AND METHOD OF PREPARING THE SAME

(71) Applicant: SK INNOVATION CO., LTD., Seoul (KR)

(72) Inventors: Chang Q LEE, Daejeon (KR); Ho Jeong LEE, Daejeon (KR); Seung Woo LEE, Daejeon (KR); Yun Ji LIM, Daejeon (KR)

(21) Appl. No.: 19/362,497

(22) Filed: Oct. 20, 2025

(30) Foreign Application Priority Data
Nov. 7, 2024 (KR) 10-2024-0157308

(51) Int. Cl. B01J 29/70; B01J 21/04; B01J 23/75; B01J 29/40; B01J 37/08

(52) U.S. Cl. CPC B01J 29/703; B01J 21/04; B01J 23/75; B01J 29/40; B01J 37/08

(57) ABSTRACT

A catalyst for an FT reaction that converts a mixture of carbon monoxide (CO) and hydrogen (H₂) into liquid hydrocarbons comprising a composite carrier containing uniformly dispersed alumina and zeolite and a metal uniformly supported on the composite carrier is proposed. Herein, the metal includes Co. In addition, a method of preparing the catalyst is also proposed.

### CROSS REFERENCE TO RELATED APPLICATION

The present application claims priority to Korean Patent Application No. 10-2024-0157308, filed Nov. 7, 2024, the entire contents of which is incorporated herein for all purposes by this reference.

### BACKGROUND OF THE DISCLOSURE

### 1. Field of the Disclosure

The embodiments of the present disclosure relate to a catalyst for Fischer-Tropsch (FT) reaction and a method of preparing the same.

### 2. Description of the Related Art

Synthetic fuel (or synfuel) is generally defined as a hydrocarbon produced through a series of chemical reactions from synthesis gas, which is a mixture of carbon monoxide and hydrogen, to synthesize fuel. Synthetic fuel is distinct from hydrocarbons separated by distillation of crude oil. Among catalytic reactions for synthesizing liquid hydrocarbons from synthesis gas, a FT (Fischer-Tropsch) reaction is a representative example.

Jet fuel is fuel used in aircraft engines. Sustainable aviation fuel (SAF) refers to jet fuel made from sustainable and renewable raw materials. The raw materials may be bio-derived raw materials such as seaweed, animals/plants, and cooking oil. Alternatively, the raw materials may be synthetic raw materials prepared using carbon dioxide in the air and hydrogen derived from water.

SAF can replace conventional jet fuel without modifying conventional aircraft. SAF can reduce carbon emissions by up to 80% compared to conventional jet fuel prepared based on fossil resources such as oil and coal. Thus, SAF is gaining attention not only from the perspective that SAF can address depletion of conventional fossil resources and rising crude oil prices, but also from the perspective that SAF can help address global warming and reduce carbon dioxide emissions.

### SUMMARY

According to an embodiment of the present disclosure, a new catalyst which may be used in an FT reaction may be provided. According to another embodiment of the present disclosure, a method of preparing the catalyst may be provided.

The catalyst of the present disclosure may be widely applied in SAF preparation techniques, and thus the catalyst may also contribute to preventing global warming through reduction in carbon emissions.

In an embodiment of the present disclosure, a catalyst for an FT reaction may include a composite carrier including uniformly dispersed alumina (Al₂O₃) and zeolite; and a metal supported on the composite carrier, and the metal includes Co.

According to an embodiment of the present disclosure, the catalyst may have a composition uniformity of 5.0 or less, as defined by UN in Equation 1 below.

$$UN = \frac{{\sum }_{i = 1}^{i = M} \vert {C}_{A l} ( i ) - {C}_{A l} ( ave ) \vert}{M \times {C}_{Al} ( ave )} \times 100 \qquad ( Equation 1 )$$

In Equation 1, UN represents the composition uniformity. C_{Al} represents a composition of alumina with a total content (wt %) of alumina and zeolite as a denominator and an alumina content (wt %) as a numerator. C_{Al}(ave) represents an average composition of alumina on a cross-section of a carrier across the center of the composite carrier. C_{Al}(i) represents a composition of alumina at the i-th numbered location when sequential numbers are assigned to locations spaced at regular intervals along a straight reference line crossing the center of the cross-section of the carrier. M represents a total number of the locations, where the composition of alumina is measured on the reference line, and is a natural number from 20 to 500.

According to an embodiment of the present disclosure, the zeolite may have an MRE structure or an MFI structure.

According to an embodiment of the present disclosure, the zeolite may include EU-2, ZSM-5, ZSM-48, or a combination thereof.

According to an embodiment of the present disclosure, a weight ratio of the alumina to the zeolite in the composite carrier may be 1:1 to 1:5.

According to an embodiment of the present disclosure, a content of the composite carrier in the catalyst may be at least 80 wt %.

According to an embodiment of the present disclosure, the metal may further include Fe.

According to an embodiment of the present disclosure, a content of the metal in the catalyst may be at least 5 wt %.

According to an embodiment of the present disclosure, the catalyst may further include a co-catalyst metal.

According to an embodiment of the present disclosure, the co-catalyst metal may include yttrium (Y), cerium (Ce), lanthanum (La), tungsten (W), molybdenum (Mo), or a combination, or a combination thereof.

According to an embodiment of the present disclosure, a content of the co-catalyst metal in the catalyst may be at least 1 wt %.

According to an embodiment of the present disclosure, the catalyst may show a reduction peak at 600° C. or higher, as measured by hydrogen temperature-programmed reduction (H₂-TPR).

In another embodiment of the present disclosure, provided is a method of preparing a catalyst for an FT reaction. The method may include preparing a composite carrier mixture including alumina hydrate and zeolite; preparing a precursor solution of a Co-containing metal; preparing a catalyst mixture by mixing the composite carrier mixture and the precursor solution; and calcining the catalyst mixture.

According to an embodiment of the present disclosure, the preparation of the catalyst mixture may further include adding an acid to the precursor solution.

According to an embodiment of the present disclosure, the preparation of the catalyst mixture may include preparing a paste by mixing the composite carrier mixture and the precursor solution; and preparing an extrudate by extruding the paste. The calcination of the catalyst mixture may mean calcining the extrudate.

According to another embodiment a catalyst for a Fischer-Tropsch reaction that converts a mixture of carbon monoxide (CO) and hydrogen (H₂) into liquid hydrocarbons is provided, the catalyst comprising:
a composite carrier comprising uniformly dispersed alumina and zeolite; and
cobalt and iron and a cocatalyst metal on the composite carrier,
wherein a content of the co-catalyst metal in the catalyst is at least 1 wt %, and
wherein the catalyst shows a reduction peak at 600° C. or higher, as measured by hydrogen temperature-programmed reduction (H₂-TPR).

The catalyst may have a composition uniformity UN of 5.0 or less, defined by the following equation:

$$UN = \frac{{\sum }_{i = 1}^{i = M} \vert {C}_{A l} ( i ) - {C}_{A l} ( ave ) \vert}{M \times {C}_{Al} ( ave )} \times 100 ,$$

wherein,
C_{Al} represents a composition of alumina with a total content (wt %) of alumina and zeolite as a denominator and an alumina content (wt %) as a numerator,
C_{Al}(ave) represents an average composition of alumina on the cross-section of a carrier across the center of the composite carrier,
C_{Al}(i) represents a composition of alumina at the i-th numbered location when sequential numbers are assigned to locations spaced at regular intervals along a straight reference line crossing the center of the cross-section of the carrier, and
M represents a total number of locations, in which the composition of alumina is measured, on the reference line, and is a natural number from 20 to 500.

The zeolite in the catalyst may have an MRE structure or an MFI structure.

The catalyst may have a weight ratio of alumina to zeolite in the composite carrier is 1:1 to 1:5.

The content of the composite carrier in the catalyst may be at least 80 wt %.

According to an embodiment of the present disclosure, use of the catalyst in an FT reaction can increase selectivity of fractions with a boiling point below a diesel boiling point range in FT reaction products. According to another embodiment, use of the catalyst can increase a content of olefin and iso-paraffin in the FT reaction products. According to a further embodiment, an FT process using the catalyst can increase a yield of jet fuel in conjunction with a subsequent fuel oil preparation process.

### BRIEF DESCRIPTION OF THE DRAWINGS

FIG. 1 shows an SEM image of a cross-section of a catalyst carrier according to one embodiment of the present disclosure;

FIG. 2 shows dispersion of each element by EDS analysis in the cross-section of the catalyst carrier according to one embodiment of the present disclosure;

FIG. 3 shows a line profile of a composition of Al and Si on a straight reference line crossing the center of the catalyst carrier according to one embodiment of the present disclosure;

FIG. 4 shows H₂-TPR analysis results of catalysts according to some Examples and Comparative Examples; and

FIGS. 5 and 6 show performance experiment results of the catalysts of some Examples and Comparative Examples in FT reactions.

### DETAILED DESCRIPTION

Hereinafter, the embodiments of the present disclosure will be described in detail with reference to the attached drawings. However, this is merely illustrative, and the present disclosure is not limited to the specific embodiments described by way of example.

### Catalyst for FT Reaction

One embodiment of the present disclosure provides a catalyst for an FT reaction. An FT reaction product, which is liquid hydrocarbon or synthetic oil (or syncrude), may be used as a starting material for fuel oil production. Among the fuel oils, jet fuel may be obtained by isomerizing a fraction, which is of synthetic oil, with a boiling point within a kerosene boiling point range; alkylating and/or polymerizing a fraction, which is of synthetic oil, with a boiling point within a naphtha boiling range; and/or cracking a fraction with a boiling point at or above a diesel boiling range.

In the present disclosure, in relation to synthetic oil, the expressions “naphtha fraction, kerosene fraction (also called SAF fraction), and diesel+ fraction” are used. The expression “naphtha fraction” refers to a fraction with a boiling point within a naphtha boiling point range or a fraction with a carbon number within a naphtha carbon number range, and the expressions may be used interchangeably with each other. The same applies to the expressions “kerosene fraction” and “diesel+ fraction”. In the present disclosure, the naphtha fraction contains hydrocarbons having 5 to 8 carbon atoms. The kerosene fraction contains hydrocarbons with 9 to 15 carbon atoms. The Diesel+ fraction contains hydrocarbons with carbon atoms of 16 or more.

Considering the conjunction between an FT process and the above-mentioned jet fuel preparation process, the catalyst of the present disclosure is designed to produce synthetic oil with a composition that may increase production efficiency of jet fuel.

The catalyst includes a composite carrier and a metal supported on the composite carrier. The composite carrier includes alumina and zeolite. In addition, the metal includes Co.

The alumina and zeolite are uniformly dispersed within the composite carrier. In the present disclosure, the expression “uniformly dispersed” means that alumina and/or zeolite are not concentrated in specific areas within the composite carrier.

In some embodiments of the present disclosure, the uniform dispersion of alumina and zeolite may be defined by UN in Equation 1 below.

$$UN = \frac{{\sum }_{i = 1}^{i = M} \vert {C}_{A l} ( i ) - {C}_{A l} ( ave ) \vert}{M \times {C}_{Al} ( ave )} \times 100 \qquad ( Equation 1 )$$

In Equation 1, UN represents the composition uniformity. C_{Al} represents a composition of alumina with a total content (wt %) of alumina and zeolite as a denominator and an alumina content (wt %) as a numerator. C_{Al}(ave) represents an average composition of alumina on a cross-section of a carrier across the center of the composite carrier. C_{Al}(i) represents a composition of alumina at the i-th numbered location when sequential numbers are assigned to locations spaced at regular intervals along a straight reference line crossing the center of the cross-section of the carrier. M represents a total number of the locations, where the composition of alumina is measured on the reference line, and is a natural number from 20 to 500.

According to an embodiment of the present disclosure, the catalyst may have a UN in a range of 5.0 or less. Specifically, the UN of the catalyst may be 3.3 or less, more specifically 2.5 or less, more specifically 2.3 or less, and even more specifically 2.1 or less. At this time, UN may be greater than 0 and substantially 0.01 or more, but is not limited thereto.

In Equation 1, one or more of C_{Al}(i), where i is a natural number from 1 to M, may represent a composition of alumina at a location within the central area of the cross-section of the carrier, hereinafter referred to as the “carrier cross-section”. In addition, one or more of C_{Al}(i) may also represent a composition of alumina at a location within the edge area of the carrier cross-section.

Based on a radius (Rr) of the carrier cross-section in a radial direction from the center of the carrier, the central area may refer to an area within 0.01 to 0.20 Rr, specifically within 0.05 to 0.15 Rr, in the radial direction from the center of the carrier cross-section. In this case, the shape of the central area may correspond to the shape of the carrier cross-section. That is, the central area may take a shape in which the shape of the carrier cross-section is diminished by 0.01 to 0.20 Rr, specifically, by 0.05 to 0.15 Rr, based on the length.

Since the carrier is porous, there is a risk of the mounting materials intruding into the edges when the materials are mounted to fix the carrier. Due to these mounting materials, there is a risk of performing an inaccurate composition analysis. Accordingly, it is better that the edge area should be an area free from contamination of the mounting materials, excluding the edges of the carrier cross-section that are contaminated with the mounting materials. At the same time, it is better that the edge area should be an area as close to the edges of the carrier cross-section as possible to show the degree of composition uniformity in substantially the entire area of the carrier cross-section. In this context, based on a radius (Rr) of the carrier cross-section in a radial direction from the center of the carrier, the edge area may refer to an area within 0.70 to 0.95 Rr, specifically within 0.75 to 0.85 Rr, in the radial direction from the center of the carrier cross-section.

The regular intervals between the locations spaced apart along the reference line, where compositions are measured, may represent a value obtained by dividing a distance between the edge area and the central area by M. According to an embodiment of the present disclosure, the regular intervals may be 1 to 20 μm, more specifically 1 to 10 μm, and even more specifically 2 to 8 μm, but is not necessarily limited thereto.

Additionally, although the UN is concerned with the composition uniformity of alumina, the carrier is a composite carrier of alumina and zeolite, and the composition of alumina has the total content (wt %) of alumina and zeolite as the denominator and the alumina content (wt %) as the numerator. Accordingly, the composition uniformity of alumina may correspond to the composition uniformity of zeolite. Therefore, a low value of UN not only means that alumina is uniformly dispersed, but also can mean that zeolite is also uniformly dispersed.

Experimentally, the composition of alumina (C_{Al}) in Equation 1 may be calculated based on the results of Energy Dispersive Spectrometry (EDS). Specifically, C_{Al}(ave) may be a value calculated through element mapping by targeting the entire area of the carrier cross-section, where it is an area encompassing the above-mentioned edge area and central area, excluding the area contaminated by mounting materials. C_{Al}(i) may be calculated based on the measurement results for each of the locations spaced at regular intervals along the reference line in the alumina composition line profile on the cross-section of the carrier. In energy dispersive spectroscopic analysis, a working distance (WD) may be 11.6 mm. An acceleration voltage may be 15 kV. A current may be 0.4 nA. A scan speed can be 0.2 mm/msec. These may be the results of dozens or hundreds of repeated measurements.

The metal may be uniformly supported on the composite carrier. In the present disclosure, the expression “uniformly supported” means that the metal is not densely supported in a specific area of the composite carrier. Specifically, the metal is not mainly supported on alumina or mainly on zeolite, but may be evenly supported on each of alumina and zeolite. The catalyst of the present disclosure may be a composite catalyst in which a first catalyst having a metal supported on alumina and a second catalyst having a metal supported on zeolite are uniformly dispersed. The composite carrier includes alumina. The first catalyst, where the metal is supported on alumina, promotes conversion of synthesis gas into liquid hydrocarbons (e.g., fractions with a boiling point above the diesel boiling point range) with a relatively large number of carbon atoms in the FT reaction. According to an embodiment of the present disclosure, the alumina may be derived from alumina hydrate. The alumina hydrate may include boehmite, pseudo-boehmite, or combinations thereof. As will be described later, the alumina hydrate may be calcined during catalyst preparation and ultimately converted to alumina. The alumina hydrate also functions as a binder and may help the metal to be better supported on the composite carrier during catalyst production. When preparing a catalyst, when alumina is used directly instead of alumina hydrate, a problem may occur in which adhesive strength between the converted alumina and the zeolite is not maintained due to lack of binder function.

The composite carrier also includes zeolite. The second catalyst, where the metal is supported on zeolite, may increase a yield of fractions with a boiling point below the kerosene boiling point among the FT reaction products. More specifically, the use of the second catalyst may increase a yield of the naphtha fraction. In addition, the use of a second catalyst may increase selectivity of olefin and iso-paraffin in synthetic oil.

According to an embodiment of the present disclosure, the zeolite has an MRE structure or an MFI structure. Specifically, the zeolite may include EU-2, ZSM-5, ZSM-48, or a combination thereof. ZSM-5 is an MFI-type zeolite, EU-2 is disordered ferrierite-type zeolite (MRE framework), and ZSM-48 is disordered ferrierite-type zeolite (MRE framework).

In addition, the zeolite may have a silica-alumina ratio (SAR) of 20 to 200. When the SAR is less than 20, acidity is too strong. This may result in cracking reactions, thereby significantly light hydrocarbons are primarily produced. On the other hand, when the SAR exceeds 200, acidity is too weak. This may result in significantly insufficient isomerization activity and significantly weak cracking reactions.

In the catalyst of the present disclosure, the first catalyst and the second catalyst are closely spaced, for example, within a distance of several micrometers, and are uniformly dispersed throughout the entire area of the catalyst. This close and uniform dispersion of the first and second catalysts may increase the yield of the kerosene fraction as an FT reaction product.

In addition, using the catalyst of the present disclosure, the content ratio of n-paraffin:iso-paraffin in the kerosene fraction may be controlled into the range of 1:1 to 1:2. In the subsequent process of preparing jet fuel from the kerosene fraction, an isomerization process is required to satisfy jet fuel specifications such as freezing point. However, the use of the catalyst of the present disclosure allows the presence of a sufficient amount of iso-paraffin in the kerosene fraction, making it possible to omit the isomerization process.

Alumina and zeolite are uniformly dispersed within the composite carrier. However, it should be noted that this uniform dispersion does not mean that the contents of alumina and zeolite are the same. In the composite carrier, the content of zeolite may be equal to or greater than the content of alumina. According to an embodiment of the present disclosure, a weight ratio of alumina to zeolite in the composite carrier may be 1:1 to 1:5. Specifically, the weight ratio may be 1:1 to 1:4, more specifically 1:2 to 1:4, and even more specifically 1:2 to 1:3. When the ratio is less than 1:1, a problem may occur in which a function of the zeolite in the catalyst is weakened. On the other hand, when the ratio exceeds 1:5, the amount of alumina hydrate is insufficient, thereby, problems may occur in which the adhesive strength between catalyst components decreases, and the strength of the catalyst, which is an extruded product after calcining, is weakened.

The composite carrier accounts for most of the weight of the catalyst. According to an embodiment of the present disclosure, a content of the composite carrier in the catalyst may be at least 75 wt %. Specifically, the content may be 75 to 94 wt %, more specifically 75 to 92 wt %, more specifically 75 to 89 wt %, and even more specifically 75 to 87 wt %. When the content is less than 75 wt %, the content ratio of the metal component in the catalyst becomes relatively too high, thereby, problems may occur in which the metal component is not sufficiently supported, and the particles become large, reducing the efficiency of the catalyst. From the viewpoint of FT reaction efficiency and/or catalyst durability, the content of the composite carrier may be 90 wt % or less.

The catalyst contains a metal including Co. A content of the metal in the catalyst may be at least 5 wt %. Specifically, the content may be 5 to 20 wt %, more specifically 7 to 20 wt %, more specifically 8 to 20 wt %, and even more specifically 10 to 20 wt %. According to some embodiments, a particle size of the metal may be 1 μm or less. Herein, the particle size means the longest length of a particle. In addition, according to some embodiments, the metal may further include Fe.

The catalyst may further include a co-catalyst metal. According to an embodiment of the present disclosure, the co-catalyst metal may be supported on the composite carrier. The co-catalyst metal may contribute to controlling a reaction rate of Co, adjusting a chain length of the FT reaction product, and increasing the selectivity of olefin. For example, a content of the olefin in the naphtha fraction of the FT reaction product, which is obtained by using the catalyst of the present disclosure containing a co-catalyst metal, may be 50 wt % or more. In a subsequent process of preparing jet fuel from the naphtha fraction, olefin is required for oligomerization. Thus, increasing the content of the olefin in the naphtha fraction may increase jet fuel production efficiency without additional olefin supply.

The metal that may be used as the co-catalyst metal is not particularly limited as long as the metal is intended to achieve the above-mentioned purpose. For example, the co-catalyst metal may include Y, Ce, La, W, Mo, or a combination thereof.

According to an embodiment of the present disclosure, a content of the co-catalyst metal in the catalyst may be at least 1 wt %. Specifically, the content may be 1 to 5 wt %, more specifically 1 to 4 wt %, and more specifically 1 to 3 wt %. When the content of the co-catalyst metal is below the range, it may not be sufficient to control the properties of the metal such as Co in the catalyst. On the other hand, when the content of the co-catalyst metal exceeds the range, the problem of excessively weakening the activity of the metal may occur. According to some embodiments, a weight ratio of metal to co-catalyst metal may be 3:1 to 10:1.

When the catalyst of the present disclosure is in a deactivated state, the metal and co-catalyst metal may exist in the form of metal oxide. Activation of the catalyst may be performed by reducing the metal oxide using hydrogen. According to an embodiment of the present disclosure, the catalyst may show a reduction peak at 600° C. or higher, as measured by hydrogen temperature-programmed reduction (H₂-TPR). Specifically, the catalyst may include a maximum reduction peak at 600° C. or higher, as measured by H₂-TPR. Without being bound by a specific theory, it is believed that the presence of the reduction peak as described above is due to the strong interaction between the metal component and the composite carrier. This strong interaction may control the selectivity of the FT reaction product by partially suppressing the activity of the metal component. As a result, it is possible to reduce the production of diesel+fraction as a FT reaction product and also increase the production of iso-paraffin and olefin.

When used in an FT reaction, the catalyst of the present disclosure increases a conversion rate of syngas to liquid hydrocarbons and increases a yield of fractions with a boiling point equal or below the kerosene boiling point compared to the diesel fraction. Among them, the catalyst of the present disclosure may increase a yield of the kerosene fraction and increase an olefin and iso-paraffin selectivity of the product. Among the FT reaction products produced in this way, the kerosene fraction may be used as a jet fuel product without an additional isomerization process. The naphtha fraction may be converted to a jet fuel product through a conversion reaction without additional olefin supply. Therefore, it is expected that the catalyst of the present disclosure may improve an overall yield of jet fuel by being used in conjunction with a jet fuel preparation process after the FT process.

### Method of Preparing Catalyst for FT Reaction

Another embodiments of the present disclosure provides a method of preparing a catalyst for an FT reaction. Unless otherwise stated, it should be noted that the detailed description of each component mentioned in the catalyst for an FT reaction described above may be equally applied to the common components described in the catalyst preparation method below.

The method of preparing a catalyst for an FT reaction includes preparing a composite carrier mixture including alumina hydrate and zeolite; preparing a precursor solution of a Co-containing metal; preparing a catalyst mixture by mixing the composite carrier mixture and the precursor solution; and calcining the catalyst mixture.

In the present disclosure, a metal precursor is not particularly limited as long as the metal precursor may provide a corresponding metal atom when preparing the catalyst mixture. Considering the addition of acid as described later, specifically, the metal precursor may be a salt of a metal and acid. According to an embodiment of the present disclosure, the salt may specifically include nitrate, sulfate, chloride, acetate, or a combination thereof.

According to an embodiment of the present disclosure, the precursor solution may be a mixed solution of the metal precursor and a co-catalyst metal precursor. The metal precursor and co-catalyst metal precursor in the precursor solution may be converted into a metal and co-catalyst metal, respectively, before mixing with the composite carrier mixture. According to an embodiment of the present disclosure, the preparation of the catalyst mixture may further include adding an acid to the precursor solution. The addition of the acid may be performed before the precursor solution and the composite carrier mixture are mixed. The addition of the acid may dissociate the metal from the precursor solution and convert the metal into an ionic form.

As the acid, nitric acid, sulfuric acid, hydrochloric acid, acetic acid, or a combination thereof may be used. From the viewpoint of preventing poisoning due to residual salts, the acid may include nitric acid, acetic acid, or a combination thereof. In addition, from the viewpoint of strength of the catalyst paste, the acid may include nitric acid.

The catalyst mixture may be prepared by an impregnation or co-mulling method. In terms of streamlining the work steps and maintaining the strength of the extrudate, specifically, the catalyst mixture may be prepared by the co-mulling method. According to an embodiment of the present disclosure, the preparation of the catalyst mixture may include preparing a paste by mixing the composite carrier mixture and the precursor solution; and preparing an extrudate by extruding the paste. In this case, calcining the catalyst mixture, subsequently implemented, is replaced by calcining the extrudate.

For the paste preparation, mixing may be performed by adding the precursor solution to the composite carrier mixture in small portions several times. The prepared paste may be made into an extrudate through a known extruder. The extrudate may be cut to an appropriate length as needed.

The catalyst mixture or extrudate undergoes a calcining treatment. According to an embodiment of the present disclosure, the calcining treatment may include, a first calcination according to which the catalyst mixture or extrudate may be first calcined at a temperature of 80° C. to 200° C. for 1 to 10 hours and, then, subjecting the catalyst mixture or the extrudate to a second calcining treatment at a temperature of 400° C. to 700° C. for 1 to 10 hours. Specifically, the first calcination may be performed at a temperature of 100° C. to 150° C. for 3 to 8 hours. When the temperature of the first calcination is below the above range, a problem may occur in which moisture in the catalyst mixture or extrudate is not sufficiently removed. On the other hand, when the temperature of the primary calcination exceeds the range, the secondary calcination reaction may be performed without moisture being removed. In this case, a problem may occur in which the structure of the composite carrier becomes prone to collapse.

In addition, specifically, the secondary calcination may be performed at a temperature of 500° C. to 600° C. for 3 to 8 hours. When the temperature of the secondary calcination is below the range, problems such as insufficient removal of the remaining metal salt component in the catalyst mixture or extrudate, insufficient structural change of alumina hydrate to alumina, and insufficient removal of ammonia in the zeolite component may occur. On the other hand, when the temperature of the secondary calcination exceeds the range, problems such as structural change of alumina (e.g., gamma-alumina) and structural collapse of zeolite may occur.

The catalyst of the present disclosure may be prepared through the processes described above.

Hereinafter, embodiments of the present disclosure will be further described with reference to specific experimental examples. The examples and comparative examples included in the experimental examples only illustrate some of the embodiments of the present disclosure and do not limit the scope of the appended claims. It is apparent to those skilled in the art that various changes and modifications to the embodiments are possible within the scope and spirit of the present disclosure. It is natural that such variations and modifications fall within the scope of the appended claims. Furthermore, the embodiments may be combined to form additional embodiments.

### EXAMPLES

### 1. Preparation of Catalysts

### (1) Examples 1A-1F

16.1 g of MFI zeolite (SiO₂/Al₂O₃=30) and 7.9 g of pseudo-boehmite were mixed in a roller for 12 hours. A 1 M nitric acid (HNO₃) solution was prepared and added to the mixture of zeolite and pseudo-boehmite, and then the mixture was mixed to form a paste of a composite carrier. The paste was extruded using extrusion equipment, and an extruded product was cut to have a size of 2 mm in diameter×10 mm in length. The extrudate was calcined at 120° C. for 5 hours and 550° C. for 5 hours in an air atmosphere. Herein, a temperature increase rate was 2° C./min. The calcined extrudate was pulverized and meshed to prepare an MFI composite carrier as a particle with a diameter of 0.4 to 1.2 mm.

A cobalt nitrate compound and a nitrate compound of each of co-catalyst metals were metered and added to 10 g of distilled water and then dissolved. The nitrate compounds were quantified so that the contents in the final catalyst became 10 wt % and 3 wt %, respectively. Each of the metal mixture solution was added to 1.43 g of the MFI composite carrier prepared previously and mixed for 30 minutes. Each of the resulting mixture was placed in an oven set at 80° C., and the water was volatilized. The catalysts of Example 1 were prepared by calcining and meshing the dried samples. The calcining and mesh processing were the same as the calcining process of the MFI composite carrier extrudate described above. Table 1 below shows the components of the catalysts of Example 1.

TABLE 1

| Example | 1A | 1B | 1C | 1D | 1E | 1F |
|---|---|---|---|---|---|---|
| Metal | Co | Co | Co | Co | Co | Co |
| Co-catalyst Metal | — | Y | Mo | La | Ce | W |
| Zeolite | MFI | MFI | MFI | MFI | MFI | MFI |

### (2) Examples 2A-2F

16.1 g of MFI zeolite (SiO₂/Al₂O₃=30), 14.7 g of MRE zeolite, or 14.8 g of hierarchical MRE zeolite were prepared. One type of zeolite selected from the zeolites and 7.9 g of pseudo-boehmite were mixed in a roller for 12 hours to prepare a composite carrier mixture.

A catalyst precursor mixed solution was prepared by dissolving a Co-nitrate compound and a nitrate compound of a co-catalyst metal in 1 M nitric acid (HNO₃) solution. A metal and co-catalyst metal were quantified in the same manner as Example 1. The catalyst precursor mixed solution was added to each of the composite carrier mixtures of the different zeolites and the pseudo-boehmite and mixed to prepare a paste. Each paste was extruded using extrusion equipment, and each extruded product was cut to have a size of 2 mm in diameter×10 mm in length. The catalysts of Example 2 were prepared by calcining and meshing each extrudate. The calcining and meshing were performed under the same conditions as the calcining and meshing in Example 1. Table 2 shows the components of the catalysts of Example 2. Herein, h-MRE represents hierarchically porous MRE zeolite.

TABLE 2

| Example | 2A | 2B | 2C | 2D | 2E | 2F |
|---|---|---|---|---|---|---|
| Catalyst Metal | Co | Co | Co | Co | Co | Co |
| Co-catalyst Metal | — | Ce | — | Ce | — | Ce |
| Zeolite | MFI | MFI | MRE | MRE | h-MRE | h-MRE |

### (3) Comparative Example

A Co precursor solution was prepared by dissolving 27.4 g of a Co-nitrate (Co(NO₃)₂-6H₂O) compound in 100 g of distilled water at room temperature. After adding and mixing 50 g of Al₂O₃ extrudate to the Co precursor solution, the mixed solution was put into a rotary evaporator. A Co-supported extrudate (wet-extrudate) was prepared by volatilizing distilled water in the rotary evaporator (Rotary Bath temperature: 80° C. to 95° C., pressure: 100 to 200 mmHg, and rpm: 40 to 100). The extrudate (wet-extrudate) was placed in an oven and dried at 80° C. for 12 hours. The catalyst of Comparative Example was prepared by calcining and meshing the dried sample. The calcining and meshing were performed under the same conditions as the calcining and meshing in Example 1.

### 2. Confirmation of SEM Image of Prepared Catalysts and Dispersion of Components

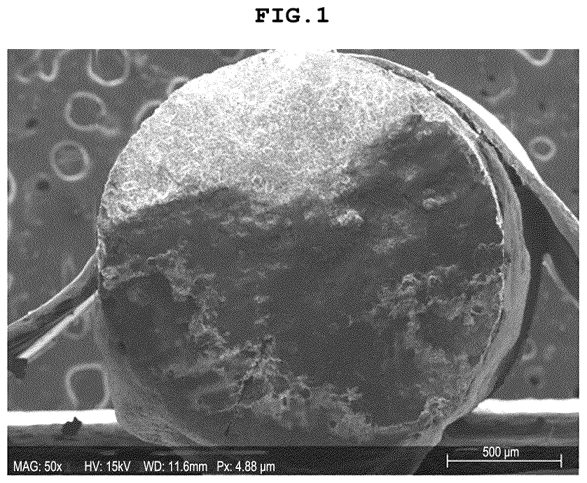

An SEM image of a cross-section of the catalyst extrudate of Example 1E is shown in FIG. 1.

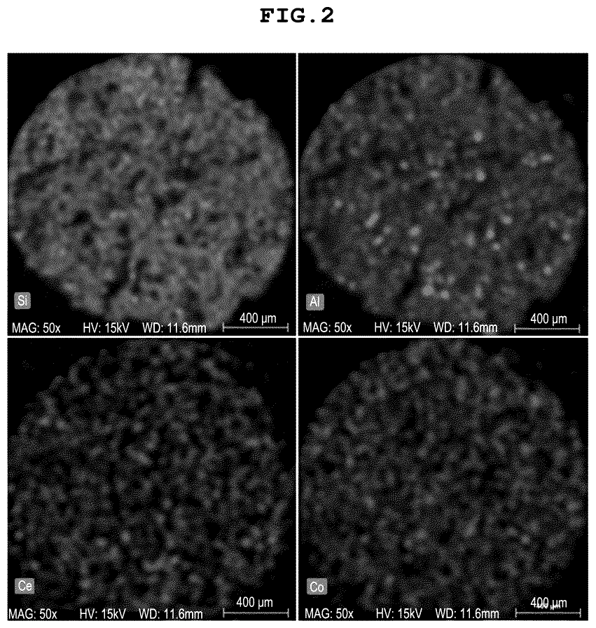

The dispersion of each element according to EDS analysis in the cross-section is shown in FIG. 2. Herein, Al represents the dispersion of alumina and zeolite, and Si represents the dispersion of zeolite.

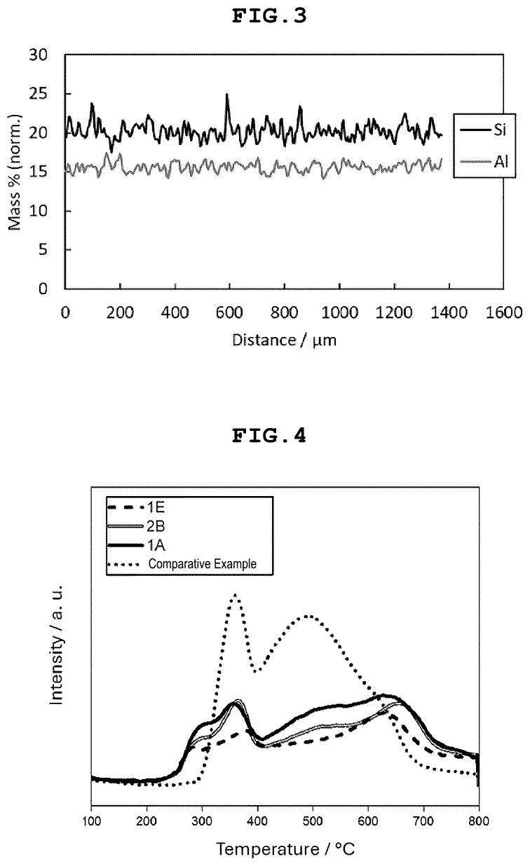

The line profile of the composition of aluminum and silicon on the reference line crossing the center of the cross-section of the extrudate of Example 1E was calculated based on the results of energy dispersive spectrometry (EDS). The results are shown in FIG. 3. As a result of calculating a UN according to Equation 1 for the two samples, the UN of the two samples was calculated as 2.42 and 3.24, respectively.

From FIGS. 1 to 3, it was confirmed that the composite carriers were uniformly dispersed within several micrometers in the catalysts of Examples, and the metal and co-catalyst metal are also uniformly supported on the composite carriers.

### 3. H₂-TPR Analysis

A hydrogen temperature-programmed reduction (H₂-TPR) analysis was performed using Micromeritics' Autochem II equipment. 100 mg of samples was used. Prior to the measurements, each sample was heated to 150° C. under a nitrogen (N₂) condition, and the condition was maintained for 2 hours, and then each sample was cooled to room temperature. Then, the signal (baseline) of a TCD detector (thermal conductivity detector) was stabilized, and then measurements were performed in an atmosphere of 50 sccm (cc/min) flowing gas (6.82% hydrogen, balance helium He). The measurements were performed while increasing the temperature from room temperature to 800° C. at a ramp rate of 10° C./min.

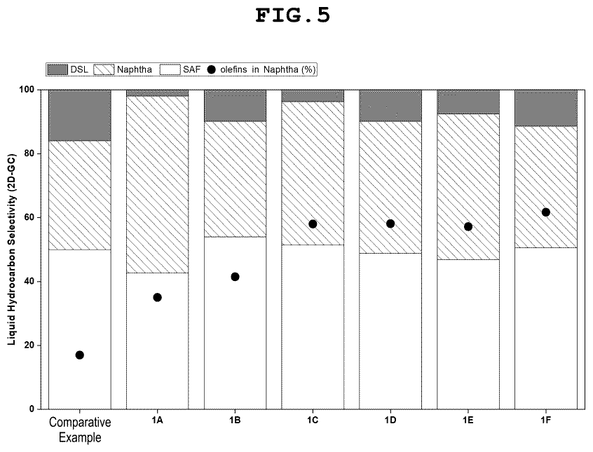

The H₂-TPR results of Examples 1A, 1E, and 2B, and Comparative Example are shown in FIG. 4. From FIG. 4, it was confirmed that the catalysts of the Examples compared to the Comparative Example showed a maximum reduction peak at 600° C. or higher. Although not to be bound by theory, the presence of a reduction peak at such a high temperature may be due to the strong interaction between the metal component of each of the catalysts of Examples and the composite carriers.

### 4. Catalyst Performance Experiments

The catalysts of the Examples and of the Comparative Example prepared previously were tested for their performance through the following procedures.

After mixing 1.43 g of each of the catalysts and 10 g of SiC, each of the mixtures was placed in a fixed bed reactor. As a pretreatment process, temperature was raised to 420° C. at a rate of 2° C./min while flowing hydrogen at a flow rate of 20 cc/min at an ambient pressure. Then, the catalyst metal of each of the catalysts was reduced and activated for 12 hours and cooled to room temperature. Reaction gas was changed from hydrogen to syngas (H₂ 60%+CO 30%+Ar 10%), and the reaction pressure was set to 20 Bar. Then, reactions were started by raising the temperature to 250° C. at a temperature increase rate of 2° C./min while flowing the syngas at a flow rate of 50 cc/min. After a period of 100-hours reaction, cooling to room temperature was performed. Reaction liquid products in each case were recovered using a hot trap and cold trap.

The recovered liquid products in each case were subjected to 2D-GC analysis and were separated into normal-paraffin, iso-paraffin, olefin, naphthene, and aromatic by carbon number and quantified. Specifically, Agilent 7890A equipment was used which has two columns (DB-5, DB-Wax) and a modulator. The liquid products in each case were mixed at 10% in a methylene chloride solvent and injected at 1 μl (Split Ratio 100:1). A GC oven was heated from 40° C. to 250° C. at a rate of 2° C./min.

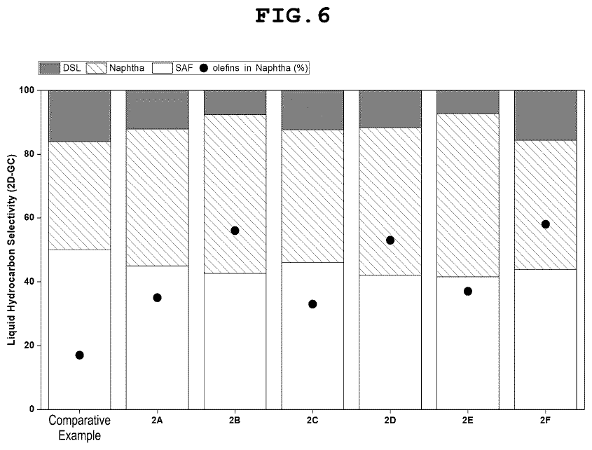

The results of component analysis of each of the liquid products recovered from the catalyst performance experiments for each catalyst, which were prepared in Examples 1 to 2 and Comparative Examples, are shown in FIGS. 5 and 6. The ratio of naphtha, SAF, and diesel fractions in the liquid products for each catalyst and the olefin content in naphtha are shown. All of the ratios and contents are on a weight basis.

The experimental results showed that when using the catalysts of the Examples, the production of diesel fractions decreased significantly in comparison to when using compared the Comparative Example catalyst, and also that the olefin content in the naphtha increased significantly. In particular, it was confirmed that in the case of the catalysts containing a co-catalyst metal among the catalysts of the Examples, the olefin content in the naphtha was 40 wt % or more.

In summary, it has been found rather unexpectedly that the catalysts of the present disclosure induce a strong interaction with the metal by using composite carriers. As a result, the catalysts reduce the production of diesel fractions in the FT reaction product and increase the production of iso-paraffin and olefin. Thus, it is expected that the use of the catalysts of the present disclosure in the FT reaction process may offer a synergistic effect, which means that the use of the catalysts may be in conjunction with a subsequent process to convert the naphtha fractions into jet fuel products, thereby increasing the production of jet fuel.

The described embodiments are merely examples of implementing the principles and technical concepts of the present disclosure. Therefore, it should be understood that other configurations, or implementations may be further included within the scope of the present disclosure as defined in the following claims.

What is claimed is:

1. A catalyst for a Fischer-Tropsch reaction, the catalyst comprising:
a composite carrier comprising uniformly dispersed alumina and zeolite; and
a metal supported on the composite carrier,
wherein the metal comprises Co.

2. The catalyst of claim 1, wherein the catalyst has a composition uniformity of 5.0 or less, as defined by UN in Equation 1 below:
$$UN = \frac{{\sum }_{i = 1}^{i = M} \vert {C}_{A l} ( i ) - {C}_{A l} ( ave ) \vert}{M \times {C}_{Al} ( ave )} \times 100 , \qquad Equation 1 ,$$
wherein, in Equation 1, UN represents the composition uniformity,
C_{Al} represents a composition of alumina with a total content (wt %) of alumina and zeolite as a denominator and an alumina content (wt %) as a numerator,
C_{Al}(ave) represents an average composition of alumina on the cross-section of a carrier across the center of the composite carrier,
C_{Al}(i) represents a composition of alumina at the i-th numbered location when sequential numbers are assigned to locations spaced at regular intervals along a straight reference line crossing the center of the cross-section of the carrier, and
M represents a total number of locations, in which the composition of alumina is measured, on the reference line, and is a natural number from 20 to 500.

3. The catalyst of claim 1, wherein the zeolite has an MRE structure or an MFI structure.

4. The catalyst of claim 1, wherein the zeolite comprises EU-2, ZSM-5, ZSM-48, or a combination thereof.

5. The catalyst of claim 1, wherein a weight ratio of alumina to zeolite in the composite carrier is 1:1 to 1:5.

6. The catalyst of claim 1, wherein a content of the composite carrier in the catalyst is at least 80 wt %.

7. The catalyst of claim 1, wherein the metal further comprises Fe.

8. The catalyst of claim 1, wherein a content of the metal in the catalyst is at least 5 wt %.

9. The catalyst of claim 1, wherein the catalyst further comprises a co-catalyst metal.

10. The catalyst of claim 9, wherein the co-catalyst metal comprises Y, Ce, La, W, Mo, or a combination thereof.

11. The catalyst of claim 9, wherein a content of the co-catalyst metal in the catalyst is at least 1 wt %.

12. The catalyst of claim 1, wherein the catalyst shows a reduction peak at 600° C. or higher, as measured by hydrogen temperature-programmed reduction (H₂-TPR).

13. A method of preparing a catalyst for an FT reaction, the method comprising:
preparing a composite carrier mixture comprising alumina hydrate and zeolite;
preparing a precursor solution of a Co-containing metal;
preparing a catalyst mixture by mixing the composite carrier mixture and the precursor solution; and
calcining the catalyst mixture.

14. The method of claim 13, wherein the preparation of the catalyst mixture further comprises adding an acid to the precursor solution.

15. The method of claim 13, wherein the preparation of the catalyst mixture comprises:
preparing a paste by mixing the composite carrier mixture and the precursor solution; and
preparing an extrudate by extruding the paste, and
the calcination of the catalyst mixture means calcining the extrudate.

16. A catalyst for a Fischer-Tropsch reaction that converts a mixture of carbon monoxide (CO) and hydrogen (H₂) into liquid hydrocarbons, the catalyst comprising:
a composite carrier comprising uniformly dispersed alumina and zeolite; and
cobalt and iron and a cocatalyst metal on the composite carrier,
wherein a content of the co-catalyst metal in the catalyst is at least 1 wt %, and
wherein the catalyst shows a reduction peak at 600° C. or higher, as measured by hydrogen temperature-programmed reduction (H₂-TPR).

17. The catalyst of claim 16, wherein the catalyst has a composition uniformity UN of 5.0 or less, defined by the following equation
$$UN = \frac{{\sum }_{i = 1}^{i = M} \vert {C}_{A l} ( i ) - {C}_{A l} ( ave ) \vert}{M \times {C}_{Al} ( ave )} \times 100 ,$$
wherein,
C_{Al} represents a composition of alumina with a total content (wt %) of alumina and zeolite as a denominator and an alumina content (wt %) as a numerator,
C_{Al}(ave) represents an average composition of alumina on the cross-section of a carrier across the center of the composite carrier,
C_{Al}(i) represents a composition of alumina at the i-th numbered location when sequential numbers are assigned to locations spaced at regular intervals along a straight reference line crossing the center of the cross-section of the carrier, and
M represents a total number of locations, in which the composition of alumina is measured, on the reference line, and is a natural number from 20 to 500.

18. The catalyst of claim 16, wherein the zeolite has an MRE structure or an MFI structure.

19. The catalyst of claim 16, wherein a weight ratio of alumina to zeolite in the composite carrier is 1:1 to 1:5.

20. The catalyst of claim 16, wherein a content of the composite carrier in the catalyst is at least 80 wt %.
